(19) United States
(12) Patent Application Publication
(10) Pub. No.: US 2020/0307861 A1
(43) Pub. Date: Oct. 1, 2020

(54) PACKAGE AND OPENING ASSEMBLY THEREFOR

(71) Applicants: Yaron Aviv, Zoor Moshe (IL); Chen Altman, Katzir (IL)

(72) Inventors: Yaron Aviv, Zoor Moshe (IL); Chen Altman, Katzir (IL)

(21) Appl. No.: 16/819,586

(22) Filed: Mar. 16, 2020

(30) Foreign Application Priority Data
Mar. 27, 2019 (IL) 265655

(51) Int. Cl. B65D 25/20; B67B 7/46; B26B 27/00

(52) U.S. Cl. CPC B65D 25/20; B26B 27/005; B67B 7/30

(57) ABSTRACT

A package opening assembly comprising a package opening device and a securing housing, the package opening devise comprises a gripping portion and at least a cutting portion, and the package opening device is detachably integrated within the securing housing and wherein the securing housing is configured for attaching over a surface portion of a package.

### TECHNOLOGICAL FIELD

The present disclosure is directed to opening arrangement for opening packages.

### BACKGROUND ART

References considered to be relevant as background to the presently disclosed subject matter are listed below:
U.S. Patent Application Publication No. 2011/0232103
U.S. Pat. No. 5,007,171
U.S. Pat. No. 2,593,601
U.S. Pat. No. 1,553,449

Acknowledgement of the above references herein is not to be inferred as meaning that these are in any way relevant to the patentability of the presently disclosed subject matter.

### BACKGROUND

Paper cuts, occur when paper's edge slides past its restraints into the flesh, resulting in a razor sharp cut, always catching one by surprise, while opening a package (box, envelope, or whatever). It is well know that paper cuts are very painful and can be a bloody and messy situation, requiring attention to stop the bleeding. Paper cuts hurt as much as they do since they typically occur on parts of the body that are the most sensitive, such as the fingers, lips, or tongue. The nerve networks of these body parts can discriminate with exceptional clarity and specificity, sensations of pressure, heat, cold, and injury. These areas are also parts one uses all the time, so such cuts tend to reopen throughout the day dooming one to relive the pain again and again.

Also, with packages there is often the issue of locating a suitable device for opening the package.

U.S. Patent Application Publication No. 2011232103 discloses a cutting tool for a package or the like, comprising an elongated, generally flat and thin housing. An elongated slit extends rearwardly and generally longitudinally from the front end of the housing through a portion thereof. A cutting blade is mounted within the housing and has a cutting edge extending into the slit at an inner portion thereof. An upper front end portion of the housing on one side of the slit has an outwardly extending barb for forming an opening in a package. A lower front end portion of the housing on the opposite side of the slit is tapered inwardly toward the front end of the housing to terminate in a narrow end that can be interested into an opening in a package formed by the barb to position an adjacent portion of the package in the slit where it can be cut by the cutting blade when the housing is moved relative to the package.

U.S. Pat. No. 5,007,171 is directed to a bag opener of a generally “U” shaped configuration formed of a memory retentent polymeric material, including a first leg and a second leg arranged parallel relative to one another in a first position, and wherein a blade member is mounted within an interior surface of the first leg arranged parallel to beveled terminal ends of the legs to receive a bag therethrough, wherein the blade member is directed across the surface of a bag inserted between the interior surfaces of the leg members to sever a bag positioned therewithin.

U.S. Pat. No. 2,593,601 relates to a cutting device which may be employed for multiple uses either industrially or domestically; of the type in which a single edge razor blade is employed as the cutting element, comprised mainly of a back plate and an affixed sheath or holder plate designed to hold such a blade, each plate being provided with a longitudinally extended slot coinciding with each other so as to receive a threaded stud through said plates and center of the blade, said slots being adapted as a slideway by which means the blade may be extended or retracted within the holder plate by simple manual pressure without the loosening or dismantling of parts.

U.S. Pat. No. 1,553,449 relates to an improvement in a cord cutting and package opening device, for effectively and quickly cutting cords and twine for opening packages and′ for other purposes.

### GENERAL DESCRIPTION

The present disclosure is directed to a package configured with a package opening devise detachably attached over a surface of the package, and accessible for readily detaching from the package also when the package is sealed, such that the package opening devise is handy at the package opening scene.

According to a first aspect of the invention there is disclosed a package configured with a package opening assembly comprising a package opening device and a securing housing, wherein the package opening devise comprises a gripping portion and at least a cutting portion, and said package opening device is detachably integrated within the securing housing and wherein said securing housing is attached over a surface portion of the package.

According to a second aspect of the invention there is disclosed a package opening assembly comprising a package opening device and a securing housing, wherein the package opening devise comprises a gripping portion and at least a cutting portion, and said package opening device is detachably integrated within the securing housing and wherein said securing housing is configured for attaching over a surface portion of a package.

The term ‘package’ as used herein denotes any sort and form of package, e.g. containers, cardboard boxes, envelopes, soft packs, sacs, and the like, made of any material and assuming any shape and construction.

The package opening device is configured to facilitate opening the package by cutting through one or more layers of the package and/or cutting a sealing/closing agent applied over layers of the package.

Any one or more of the following featured designs and configurations can be applied to any of the aspects of the present disclosure, separately or in combinations thereof:
The package opening assembly can be configured as a flat element with the package opening device being encompassed within the securing housing;
the package opening device can be substantially surrounded by respective embracing portions of the securing housing;
at least one face of the package opening device can be substantially flush with a respective face of the securing housing. According to a particular example, a bottom face of the package opening device can be retracted as compared with a bottom face of the securing housing applied over the package, thereby facilitating punching the package opening device out of the securing housing;
the package opening device and the securing housing can be integrally manufactured;
the package opening device and the securing housing can be integrally manufactured in a molding process;
the package opening device and the securing housing can be integrally manufactured in a cutting out process, e.g. by machining, laser cutting, jet cutting, 3D printing, etc.;
the package opening device can be articulated to the securing housing through breakable ribs;
the package opening device can be detached from the securing housing by depressing it against the package surface;
the package opening device can be detached from the securing housing by lifting it from the securing housing;
the package opening device can be detached from the securing housing by tilting it against the package surface, i.e. either by lifting a portion of the package opening device whist depressing an opposite portion, or by depressing a portion of the package opening device whist lifting an opposite portion;
the housing can be configured with a recess for facilitating access to a bottom face of the package opening device, whereby a user can insert a finger or a nail portion under the package opening device for lifting it into detachment from the housing; the recess can be configured at a portion of the housing opposite the cutting edge of the package opening device;
the package opening device can be configured at a bottom face thereof, with a nail engageable portion;
the securing housing can be configured with attachment arrangement for securing to the surface portion of the package;
the attachment arrangement can be articulating tabs integral with and projecting from a bottom surface of the securing housing;
the attachment arrangement can be fasteners extending through the securing housing;
the attachment arrangements can be an adhesive layer applied at a bottom face of the securing housing;
the attachment arrangements can be an adhesive layer applied through the securing housing;
the attachment arrangements can be an adhesive applied to one or both a bottom surface of the securing housing and a surface of the package. The adhesive can be a substance applied directly to one or both of the bottom surface of the securing housing and a surface of the package, or it can be applied via a carrying member (e.g. a carrying foil), or it can be applied through openings in the securing housing. The adhesive agent can be applied in a so-called in mold labeling process (IML), or in a IML+adhesive layer process, etc.; the thickness of the package opening device does not exceed the thickness of the securing housing;
the package opening device can be disposable;
the package opening device can be made of a recycled or recyclable material;
the package opening device can be made of condensed wood, condensed paper, polymeric material;
The package opening assembly can be made of a rigid, non-pliable material;
the gripping portion can be configured for gripping between an index finger and a thumb of an individual;
the gripping portion can be configured with a depressed portion extending from at least an elevated portion;
the depressed portion can be at least partially hollowed out;
the a package opening device can be configured with a leading arm extending from a gripping portion and configured with a cutting edge portion near a proximal end of the arm;
the package opening device can be a sliding cutter configured with a leading arm extending from the gripping portion, said leading arm configured for sliding beneath a surface to be cut;
the package opening device can be configured with a leading arm extending from a gripping portion and configured with a pointed insertion edge at a distal end of the leading arm;
the package opening device can be configured with a leading arm extending from a gripping portion and configured with at least a cutting edge portion;
the package opening device can be configured with a leading arm extending from a gripping portion and configured with a serrated edge;
the cutting edge portion can be configured at a confined space defined between the leading arm and the gripping portion, whereby the cutting edge portion faces the gripping portion, such that said cutting edge portion is not exposed, rendering it finger safe;
the securing housing can assume any thickness. According to some examples, the thickness is in the range of between about 0.03 to 5.0 mm;
the package can comprise at least a stiffened portion, wherein said package opening assembly is attaches thereto;
the package can be a cardboard container, wherein the package opening assembly is attaches over an external wall surface thereof;
the package can be a soft pack, wherein the package opening assembly is attaches over an external surface thereof;
a surface portion of the package opening assembly can be used as an advertising surface;
the package opening assembly can be integral with, or integrated with the package at manufacturing of the package;
the package opening assembly can be protected by a safety layer applied over at least a portion thereof;
the package opening device can be secured by a flexible cored to the housing or to the package;
the cutting portion of the package opening devise can be configured with at least a serrated portion; and
the cutting portion of the package opening devise can extend opposite the gripping portion thereof.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a top perspective view of a cardboard package configured with a package opening assembly according to an aspect of the disclosure;

FIG. 1B is an enlarged top view of the portion marked I in FIG. 1A;

FIG. 1C is a cross section taken along line II-II in FIG. 1, however in a perspective view;

FIG. 1D is a cross section taken along line in FIG. 1, however in a perspective view;

FIG. 2 is a perspective view of a soft pack package, e.g. an envelope, configured with a package opening assembly according to an aspect of the disclosure;

FIG. 3A is a top perspective view of a package opening assembly seen in FIG. 1A;

FIG. 3B is a bottom perspective view of the package opening assembly of FIG. 3A;

FIG. 4A is a perspective sectioned side view taken along line IV-IV in FIG. 3A;

FIG. 4B is a planar view of FIG. 4A;

FIG. 4C is a planar view of FIG. 4A, however according to a modified embodiment, wherein the a bottom face of the package opening device extends above a bottom face of the securing housing;

FIG. 5 is a top planar view of the package opening device after detaching from the securing housing;

FIG. 6A illustrates how the package opening device is detached form the securing housing applied over the cardboard package of Fig. A1;

FIG. 6B illustrates gripping of the package opening device upon detaching from the securing housing;

FIGS. 7A and 7B illustrate how the package opening device is used to open the cardboard package;

FIGS. 8A and 8B are a planar view and a perspective view, respectively, of a package opening assembly according to another example of the present disclosure;

FIGS. 9A and 9B are a front perspective view and a rear perspective view of the package opening device of the assembly of FIGS. 8A and 8B;

FIGS. 10A to 10C illustrate consecutive steps of detaching the package opening device from the housing of package opening assembly of FIGS. 8A and 8B;

FIGS. 11A and 11B are a planar view and a perspective view, respectively, of a package opening assembly according to yet another example of the present disclosure;

FIGS. 12A and 12B are a front perspective view and a rear perspective view of the package opening device of the assembly of FIGS. 11A and 11B; and

FIGS. 13A to 13C illustrate consecutive steps of detaching the package opening device from the housing of package opening assembly of FIGS. 11A and 11B.

### DETAILED DESCRIPTION OF EMBODIMENTS

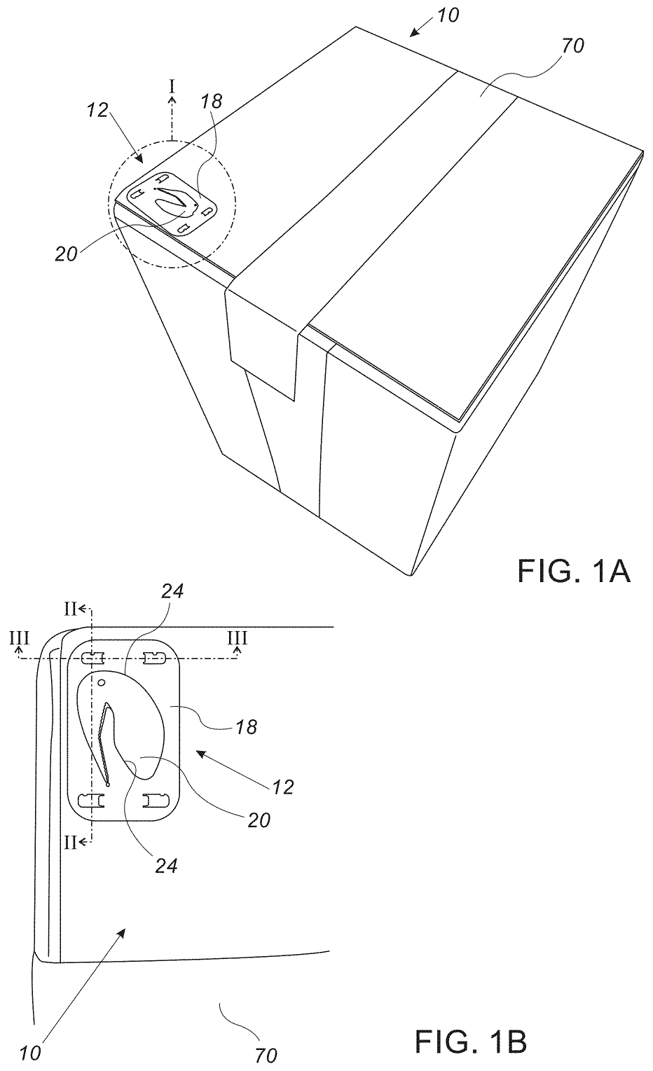

Attention is directed first to FIGS. 1A and 1B of the drawings, illustrating a cardboard container 10 of the type widely used for packing and shipping all sorts of goods. At a top corner of the cardboard container 10 there is applied a package opening assembly according to an example of the disclosure and generally designated 12.

The package opening assembly 12 is a flat body, comprising a securing housing 18 of a generally rectangular shape with rounded edges, and a package opening device 20 integral with or integrated with, and encompassed within the securing housing 18, as will be discussed hereinafter in detail.

Both members of the package opening assembly 12, namely the securing housing 18 and the package opening device 20, are rigid, non-pliable, and can be made of any material, such as metal, polymeric material, compressed paper, wood and the like, any recycled or recyclable or non-recyclable material. According to a particular example, the package opening assembly 12 is made of polymeric material and manufactured in a molding process, rendering it cheap to manufacture and of light weight. However, according to other examples, the package opening device 20 can be manufactured by other processes such as cutting out process, e.g. by machining, laser cutting, jet cutting, 3D printing, stamping, etc. In the present example the thickness of the package opening assembly 12 is about 1.0 mm (however the thickness can be of any practical dimensions).

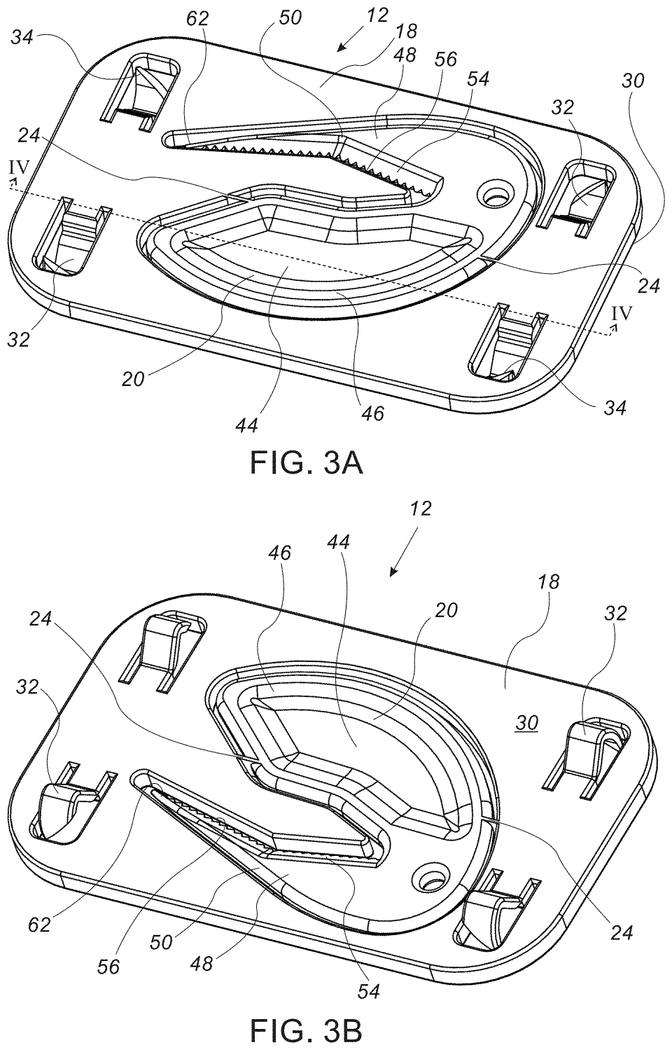

As can be seen, best in FIGS. 3A and 3B, the package opening device 20 is integral with the securing housing 18 through several breakable ribs 24, whereby applying pressure to the package opening device 20, results in breaking of the breakable ribs 24, facilitating removal of the package opening device 20 for using it.

The securing housing 18 is configured an attachment arrangement for securing it to the package, be it any sort of package. According to one configuration, the attachment arrangement is in the form of articulating tabs 32, each projecting at a respective corner from a bottom surface 30 of the securing housing. The articulating tabs 32 are hook-like shaped and have a pointed edge 34 for piercing through the surface of the package and attaching thereto. However, it is appreciated that the securing housing 18 can be articulated over the packaging surface by other arrangements. For example, an adhesive layer can be applied between the bottom surface 30 of the securing housing 18 and the surface of the package. This can be done in addition, or instead of other fastening arrangements. Likewise, the securing housing 18 can be secured to an outside surface of the package by non-integral fasteners/pins/tabs, by hot melt or even by directly molding the securing housing 18 over a surface of the package.

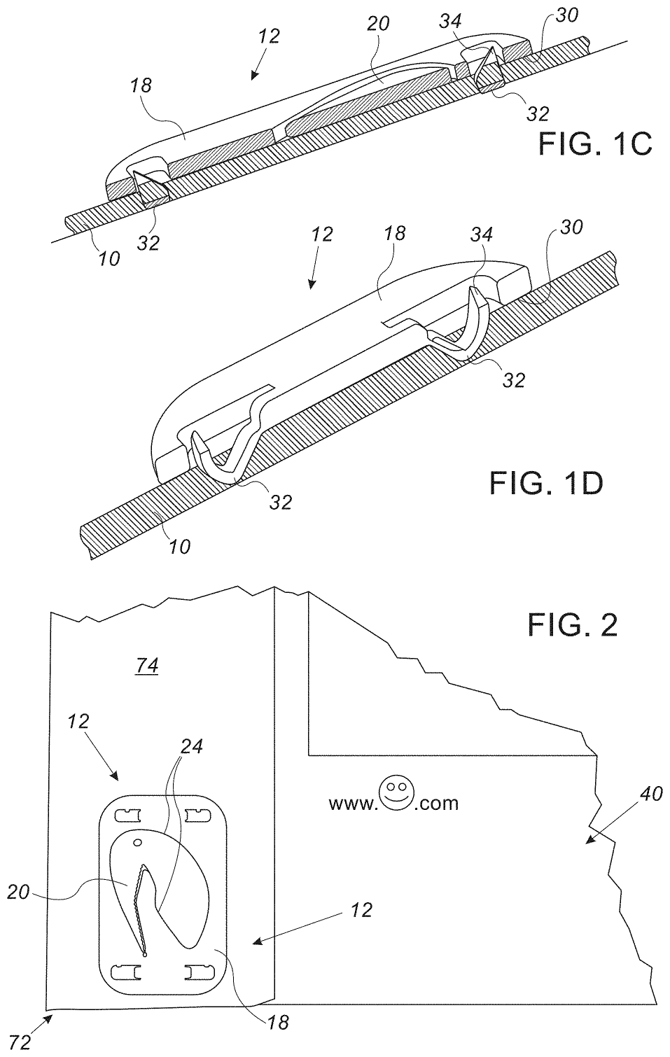

In the example of FIG. 2 the drawings there is illustrated a package in the form of an envelope 40 (partially shown). The envelope can be any sort of envelope, e.g. made of paper, cardboard or polymeric material, either pliable or non-pliable, and of any shape and size. At an outside surface of the envelope 40 there is applied the package opening assembly 12, of the kind described hereinabove and as will be discussed hereinafter in greater detail. The package opening assembly 12 cab be attached to the envelope 40 e.g. by an adhesive layer applied to the securing housing 18 (so that once detached form the securing housing 18 the package opening device 20 is loos and is readily available for use). The package opening assembly 12 may be applied directly over a surface of the envelope (as in FIG. 2), or it can be applied over a non-pliable carrier layer (not illustrated). Thus it is appreciated that the term package, as used herein throughout the specification and claims, is used in its broad sense and includes containers, cardboard boxes, envelopes, soft packs, sacs, and the like, made of any material and assuming any shape and construction.

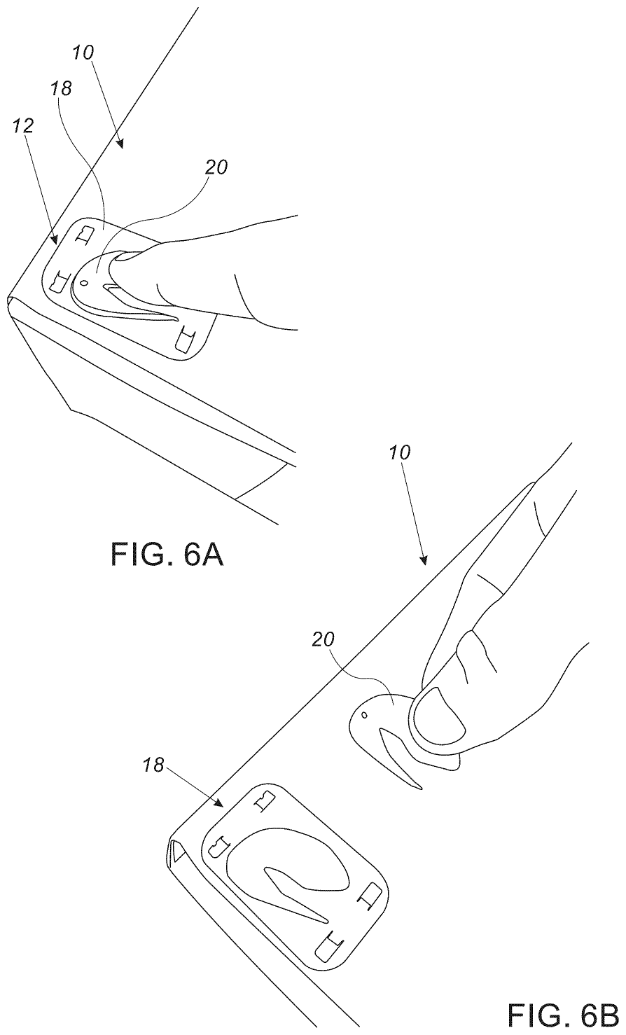

With further reference made to FIGS. 3 to 5 of the drawings, a particular shape of a package opening assembly 12 is exemplified, as already exemplified in the drawings before. The package opening device 20 is configured with a gripping portion 44 which is configured for gripping by the fingers of a user (typically between the index finger and the thumb, as illustrated in FIG. 6B). The gripping portion 44 can be solid, with a central surface coplanar with a rim 46, or the central surface can be depressed with respect to the rim 46 (i.e. be thinner) or can be configured with a void (not shown).

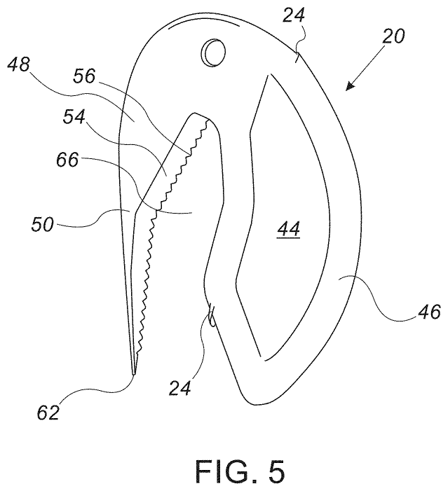

A cutting portion 48 of the of the package opening device 20 is configured with a leading arm 50 extending from the gripping portion 44 and configured with a cutting edge portion 54 near a proximal end of the leading arm 50. At least an inward facing portion 56 of the cutting edge portion 54 is configured with a sharp edge, and optionally the inward facing portion 56 is serrated. The leading arm 50 is configured at a distal end thereof with a pointed insertion edge 62. The cutting edge portion 54 is configured at a confined space 66 (FIG. 5) defined between the leading arm 50 and the gripping portion 44, such that in use said cutting edge portion 54 is not exposed, rendering it finger safe. Also, it is seen that at the a-priori assembled, intact position, (e.g. FIGS. 1 and 3) the package opening device 20 is substantially surrounded by respective embracing portions of the securing housing 18, rendering it safe and secure.

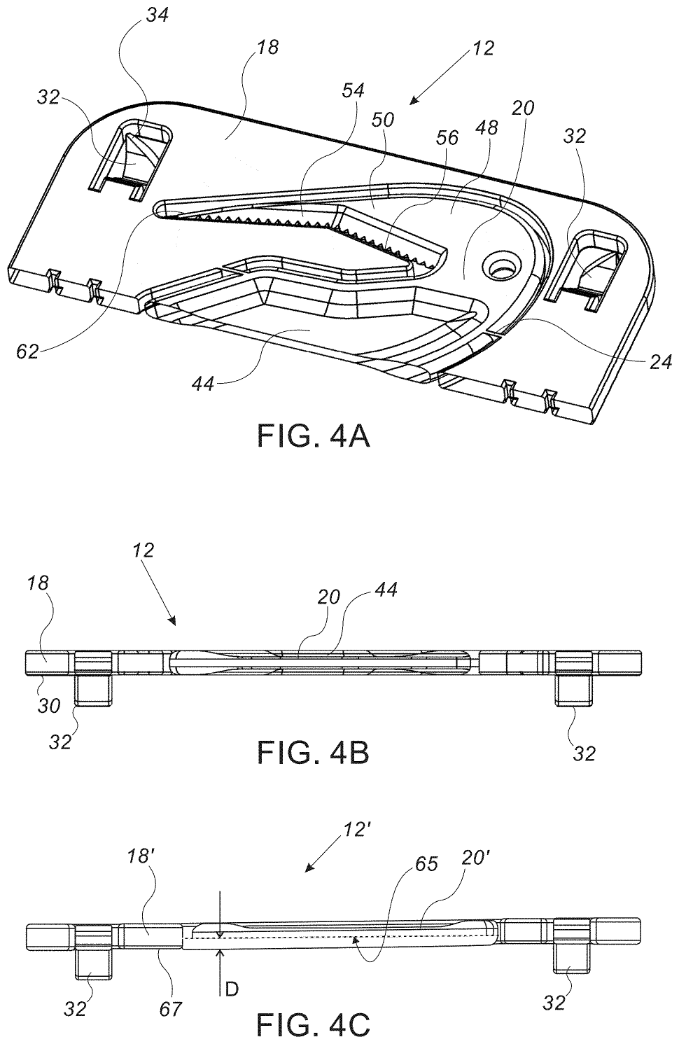

With reference to FIG. 4C of the drawings there is illustrated a modification of the package opening assembly 12′, wherein all elements and aspects are substantially similar to those disclosed hereinabove, however with a difference residing in that a bottom surface 65 of the package opening device 20′ is elevated from a bottom surface 67 of the securing housing 18′, with a gap D extending therebetween. This gap facilitates easy breaking of the several breakable ribs 24′ (not seen) for detaching the package opening device 20′ from the securing housing 18′.

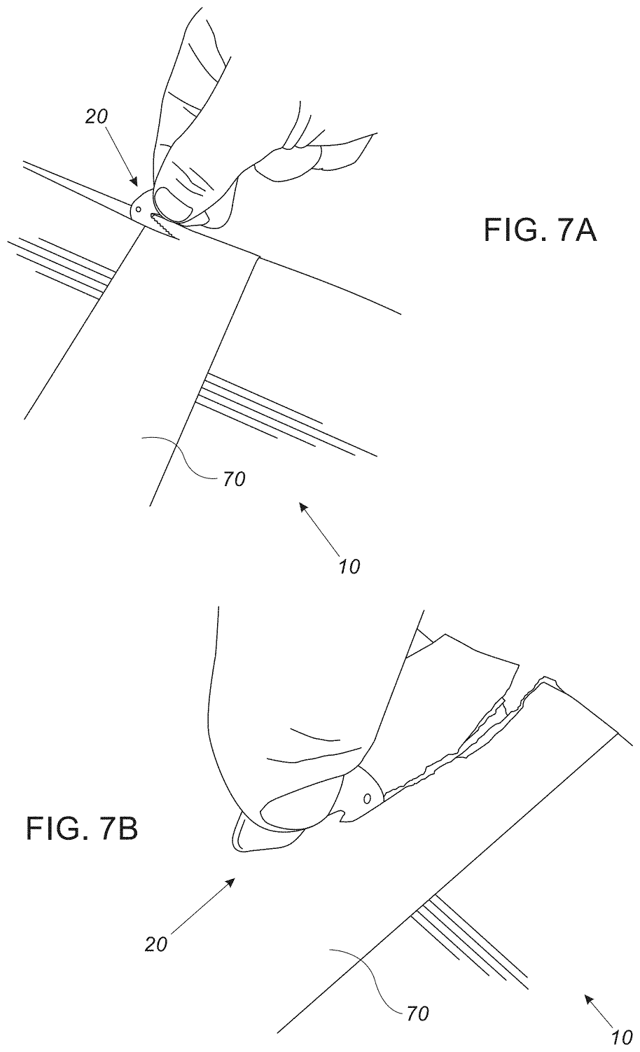

FIGS. 6A and 6B exemplify how the package opening device 20 is detached from the securing housing 18, by applying depressing the package opening device 20 such that the breakable ribs 24 break (FIG. 6A) and the package opening device 20 can be easily removed (FIG. 6B) ready for using same in opening a package (FIGS. 7A and 7B) by gripping the package opening device 20 at the gripping portion 44, typically between the index finger and the thumb, as illustrated in FIG. 6B, inserting the pointed insertion edge 62 beneath a sealing tape/closure layer 70 of the cardboard container 10 (FIGS. 1A, 1B, 7A and 7B) or at a fold 72 of a closure flap 74 of the envelope 40 (FIG. 2). Then the package opening device 20 is slidingly displaced therealong to open the closing/sealing member of the package.

Whilst in the examples hereinabove the package opening device 20 assumes a particular shape, it is appreciated that it can be configured in a variety of shapes and different configurations, without departing from the scope of the disclosure.

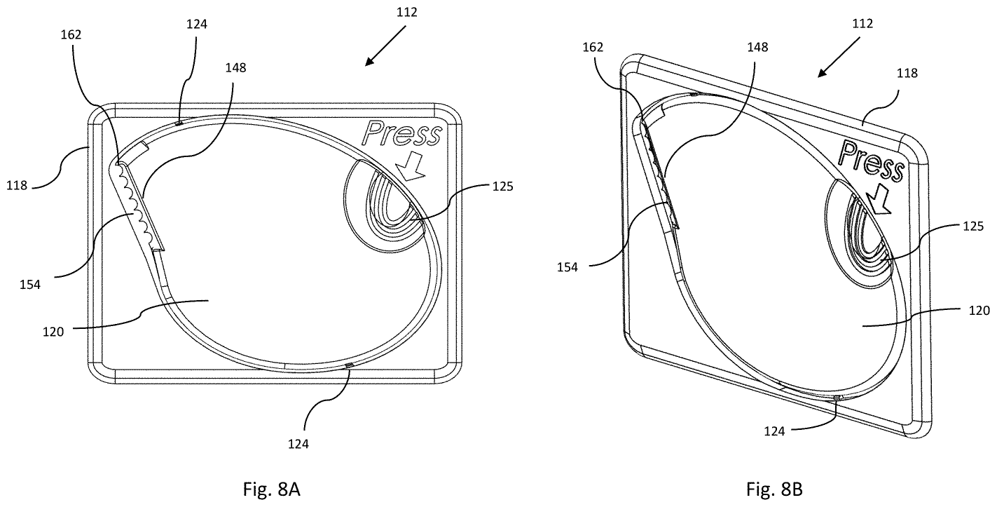

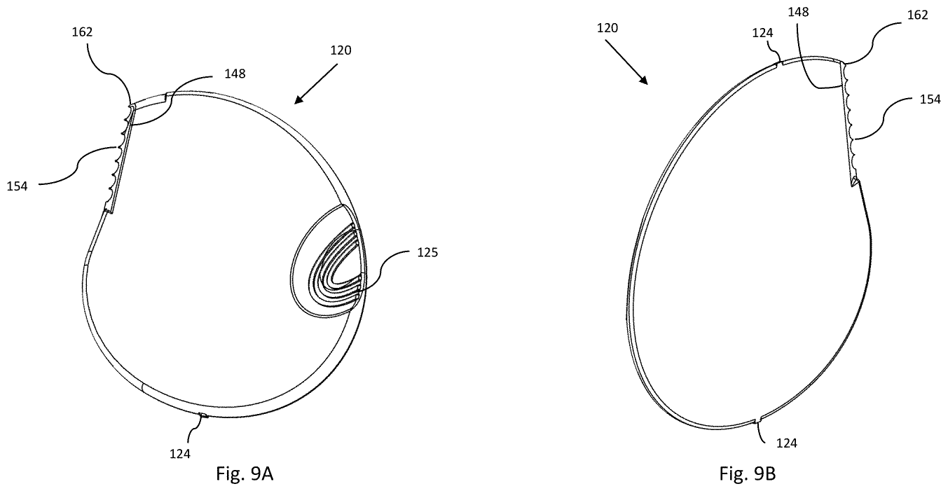

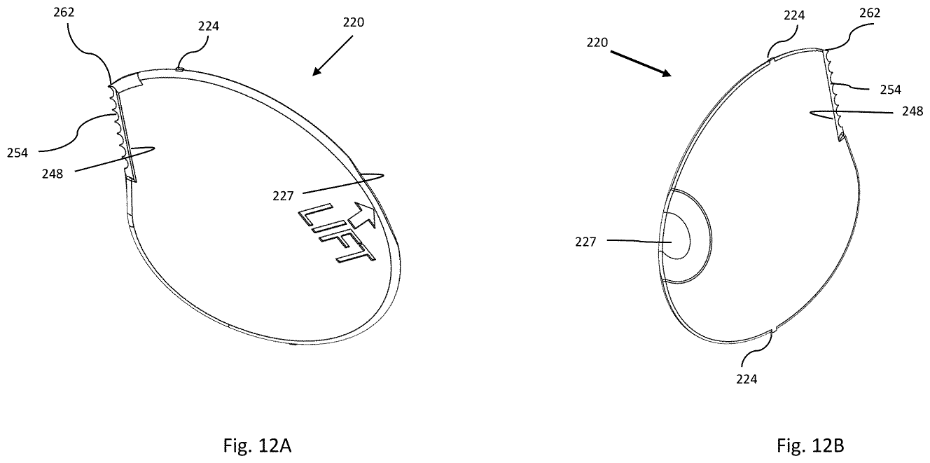

Further attention is directed to FIGS. 8 to 13, illustrating two additional examples. In the example of FIGS. 8 to 10 there is illustrated a package opening assembly generally designated 112, wherein elements similar to those depicted in the first example are designated with like reference numbers, however shifted by 100.

The package opening assembly 112 is a flat body, comprising a securing housing 118, and a package opening device 120 integral with or integrated with, and encompassed within the securing housing 118, in a co-planar fashion, both of which are made of a rigid, non-pliable material, as discussed herein before. The securing housing 118 is attachable to a package surface as discussed herein above, e.g. by an adhesive layer.

Similar to the previous examples, the package opening device 120 is integral with the securing housing 118 through several (two in the illustrated example) breakable ribs 124, and the package opening device 120 is configured with a finger pressing portion 125, whereby applying pressure to at the finger pressing portion 125 results in breaking of the breakable ribs 124, facilitating detaching and removal of the package opening device 120 for using it.

Unlike the previous examples, a cutting portion 148 of the package opening device 120 is configured with a sharp serrated cutting edge 154, having a pointed tip 162.

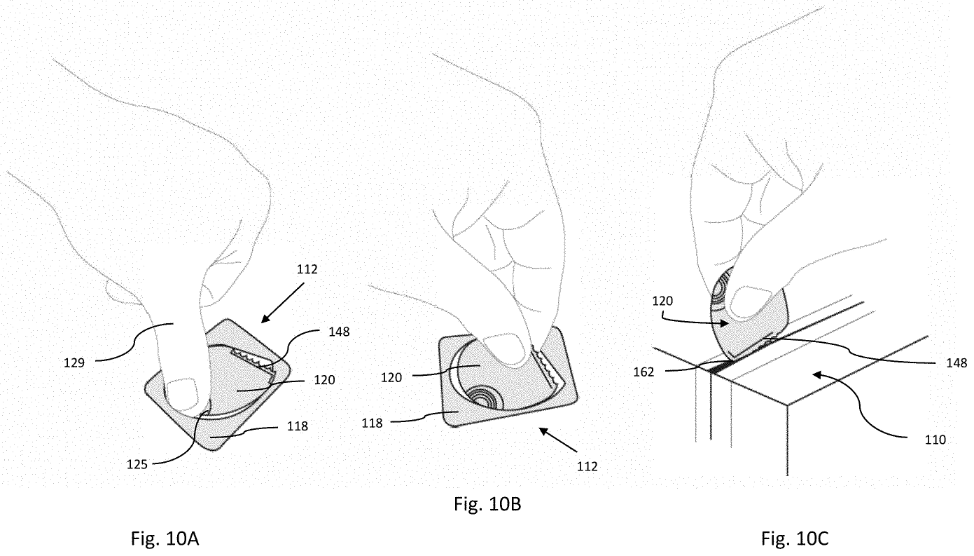

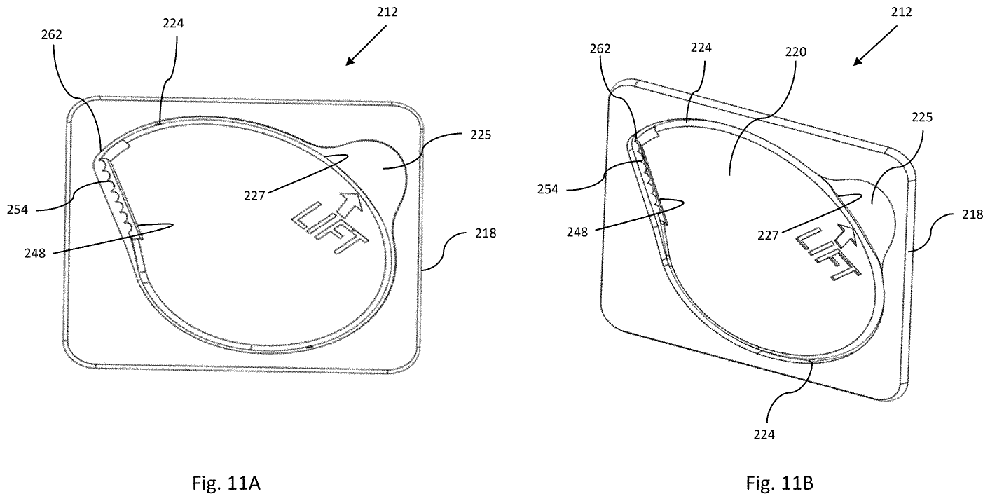

In use, a package opening assembly 112 is applied to a package 110 (FIG. 10C) and pressure is applied by a user's finger 129 (FIG. 10A) to the finger pressing portion 125, resulting in tilting the finger pressing portion 125 and twist of the breakable ribs 124 into detaching of the package opening device 120 from the securing housing 118 (FIG. 10B) whereupon the package opening device 120 can now be gripped between fingers of a user in order to efficiently and securely open the package 110 (FIG. 10C), with the pointed tip 162 facilitating piercing through the wrapping and tape of the package, and the cutting edge 154 cuts therethrough. Turning now to the example illustrated in FIGS. 11 to 13, there a package opening assembly generally designated 212, wherein elements similar to those depicted in the previous example are designated with like reference numbers, however shifted by 100.

The package opening assembly 212 is a flat body, comprising a securing housing 218, and a package opening device 220 integral with or integrated with, and encompassed within the securing housing 218, in a co-planar fashion, both of which are made of a rigid, non-pliable material, as discussed herein before. The securing housing 218 is attachable to a package surface as discussed herein above, e.g. by an adhesive layer.

Similar to the previous examples, the package opening device 220 is integral with the securing housing 218 through several (two in the illustrated example) breakable ribs 224, and the securing housing 218 is configured with a finger recess portion 225, extending opposite a finger nail groove 227 disposed at a rim portion of the package opening device 220. The package opening device 220 is configured with a cutting portion 248 having a sharp serrated cutting edge 254, having a pointed tip 262.

The arrangement is such that inserting ones fingertip into the finger recess portion 225 avails a user's fingertip/nail tip to apply lifting force to the bottom surface of the package opening device 220, resulting in breaking of the breakable ribs 224, facilitating detaching and removal of the package opening device 220 for using it, as will be exemplified hereinafter.

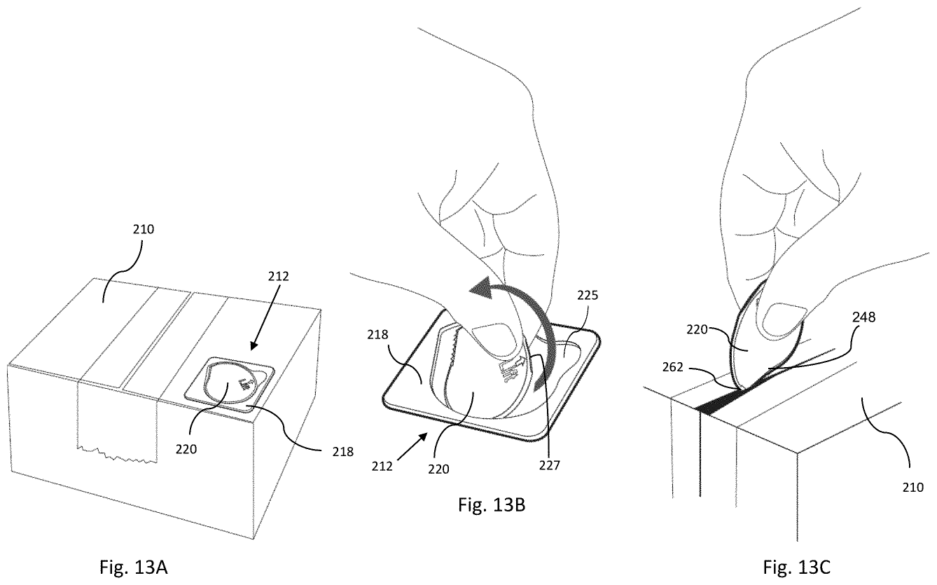

In use, a package opening assembly 212 is applied to a package 210 (FIG. 13A) and upon introducing a user's fingertip into the finger recess portion 225, user can lift the package opening device 220, tilting it so as to break the breakable ribs 224 (FIG. 13B) into detaching of the package opening device 220 from the securing housing 218 whereupon the package opening device 220 can now be gripped between fingers of a user in order to efficiently and securely open the package 210 (FIG. 13C), with the pointed tip 262 facilitating piercing through the wrapping and tape of the package, and the cutting edge 254 cuts therethrough.

1. A package, comprising:
a package opening assembly configured with the package, the package opening assembly including:
a package opening device; and
a securing housing;
wherein the package opening device comprises a gripping portion and at least a cutting portion, and said package opening device is detachably integrated within the securing housing; and
wherein said securing housing is attached over a surface portion of the package.

2. A package opening assembly, comprising:
a package opening device; and
a securing housing;
wherein the package opening devise comprises a gripping portion and at least a cutting portion, and said package opening device is detachably integrated within the securing housing; and
wherein said securing housing is configured for attaching over a surface portion of a package.

3. The package opening assembly of claim 2, wherein the package opening device is configured as a flat element with the package opening device being encompassed within the securing housing.

4. The package opening assembly of claim 2, wherein the package opening device is substantially surrounded by respective embracing portions of the securing housing.

5. The package opening assembly of claim 2, wherein at least one face of the package opening device is substantially flush with a respective face of the securing housing.

6. The package opening assembly of claim 2, wherein a bottom face of the package opening device is retracted with respect to a bottom face of the securing housing applied over the package, thereby facilitating punching the package opening device out of the securing housing.

7. The package opening assembly of claim 2, wherein the package opening device and the securing housing are integral with one another.

8. The package opening assembly of claim 2, wherein the package opening device is articulated to the securing housing through breakable ribs.

9. The package opening assembly of claim 2, wherein the securing housing is configured with an attachment arrangement for securing to the surface portion of the package.

10. The package opening assembly of claim 9, wherein the attachment arrangement is configured by a plurality of articulating tabs integral with and projecting from a bottom surface of the securing housing.

11. The package opening assembly of claim 9, wherein the attachment arrangement is configured by an adhesive layer applied at a bottom face of the securing housing.

12. The package opening assembly of claim 2, wherein the package opening device has a thickness that substantially does not exceed a thickness of the securing housing.

13. The package opening assembly of claim 2, wherein the package opening device includes a sliding cutter configured with a leading arm extending from the gripping portion, said leading arm configured for sliding beneath a surface to be cut.

14. The package opening assembly of claim 2, wherein the package opening device is configured with a leading arm extending from a gripping portion and configured with a pointed insertion edge at a distal end of the leading arm.

15. The package opening assembly of claim 2, wherein the package opening device is configured with a leading arm extending from a gripping portion and configured with at least a cutting edge portion.

16. The package opening assembly of claim 15, wherein the cutting edge portion is configured at a confined space defined between the leading arm and the gripping portion, whereby the cutting edge portion faces the gripping portion, such that said cutting edge portion is not exposed, rendering it finger safe.

17. The package opening assembly of claim 2, wherein the package opening device is configured with a leading arm extending from a gripping portion and configured with a serrated edge.

18. The package opening assembly of claim 2, wherein the package opening device is detachable from the securing housing by lifting a portion of the package opening device.

19. The package opening assembly of claim 2, wherein the package opening device is detachable from the securing housing by depressing a portion of the package opening device.

20. The package opening assembly of claim 2, wherein at least a portion of the cutting portion of the package opening devise is serrated.
